(19) United States
(12) Patent Application Publication
(10) Pub. No.: US 2016/0289097 A1
(43) Pub. Date: Oct. 6, 2016

(54) REGENERATION METHODS OF CAPACITIVE DEIONIZATION ELECTRODES

(71) Applicant: SAMSUNG ELECTRONICS CO., LTD., Suwon-si, Gyeonggi-do (KR)

(72) Inventors: Joon Seon JEONG, Seoul (KR); Hyun Seok KIM, Suwon-si (KR); Myung Dong CHO, Hwaseong-si (KR); Hyo Rang KANG, Anyang-si (KR)

(73) Assignee: Samsung Electronics Co., Ltd., Suwon-si, Gyeonggi-do (KR)

(21) Appl. No.: 15/038,111

(22) PCT Filed: Nov. 26, 2014
(86) PCT No.: PCT/KR2014/011422

§ 371 Date: May 20, 2016

(30) Foreign Application Priority Data
Nov. 27, 2013 (KR) 10-2013-0145301

(51) Int. Cl. C02F 1/469

(52) U.S. Cl. CPC C02F 1/4691; C02F 2001/46119

(57) ABSTRACT

Treating a fluid may include using a flow-through capacitor that includes first and second electrodes and a flow path between the first and second electrodes, wherein an acidic aqueous solution is supplied to the capacitor to flow through the flow path while a reverse potential difference is formed across the first and second electrodes, and thereby deposits formed in the flow-through capacitor may be removed.

### CROSS REFERENCE TO RELATED APPLICATIONS

This is a National Phase Application of PCT/KR2014/011422, filed Nov. 26, 2014, which is an International Application claiming priority to and the benefit of Korean Patent Application No. 10-2013-0145301 filed in the Korean Intellectual Property Office on Nov. 27, 2013, the entire contents of each of which are incorporated herein by reference.

### TECHNICAL FIELD

The present disclosure relates to a method of regenerating capacitive deionization electrodes, and a capacitive deionization apparatus using the same.

### BACKGROUND ARTa

In some parts of the world, the water supply may include a relatively large amount of minerals. For instance, in Europe, limestone is frequently found in underground water. Thus, tap water in these regions may contain a relatively large amount of minerals. Water having a relatively high mineral content (i.e., hard water) may cause problems including frequent occurrences of lime scale in the interior walls of pipes and decreases in energy efficiency when such water is used in home installations such as heat exchangers and/or boilers. Moreover, hard water is inappropriate to use as wash water. Therefore, an appropriate technology is utilized for removing ions from hard water to make it into soft water, in particular, in an environmentally friendly manner. Furthermore, the use of seawater desalination to obtain water has been increasing as larger and more populated areas begin to experience water shortages.

A capacitive deionization (CDI) is a fluid-treating method that removes dissolved solids (e.g., dissolved anions or cations) in a fluid to be treated by using a flow through capacitor. In the flow-through capacitor, a voltage is applied to porous electrodes having nano-sized pores to provide them with a polarity while a fluid such as hard water or sea water is allowed to flow through a flow path formed between the electrodes. As a result, the dissolved solids (e.g., ionic materials) are adsorbed from the fluid, such as hard water, onto the surface of the electrodes, thereby removing the same therefrom. In other words, when a medium containing dissolved ions flows between two electrodes of a positive electrode and a negative electrode of the capacitor and DC power having a relatively low potential difference is applied thereto, the anionic components and the cationic components among the dissolved ions are adsorbed and concentrated onto the positive electrode and the negative electrode, respectively. When an electric current flows in a reverse direction between the two electrodes or short-circuiting occurs between the two electrodes, the concentrated ions are detached from the electrodes. Since a CDI apparatus including the flow-through capacitor does not require a high potential difference, its energy efficiency is high, toxic heavy metal ions may be removed together with the hardness ions, and its recycling process does not require any chemicals.

However, when the CDI apparatus is operated for many hours, deposits such as limescale may build up on the internal surface of the apparatus (e.g., interior parts of the capacitor), which may significantly reduce efficiency of the apparatus.

### SUMMARY

Some embodiments of the present disclosure relate to a method of treating a fluid containing dissolved solids based on capacitive deionization, wherein the method may show substantially no decrease in its efficiency even when a CDI apparatus is operated for many hours.

Some embodiments of the present disclosure relate to a CDI apparatus that may be operated for many hours without showing a decrease in efficiency.

According to an example embodiment of the present disclosure, a method of treating a fluid containing dissolved solids includes:

obtaining a flow-through capacitor including at least one pair of porous electrodes including a first electrode and a second electrode including an electrode material having a surface area for electrostatic adsorption of dissolved solids; and a flow path being provided between the first electrode and the second electrode;

flowing a fluid containing dissolved solids through the flow path of the flow-through capacitor;

applying an electric potential difference across the first and second electrodes so that the first electrode becomes a positive electrode and the second electrode becomes a negative electrode, thereby adsorbing the dissolved solids contained in the fluid in the flow path to the porous electrode;

either removing the electric potential difference or applying a first reverse electric potential difference across the first and second electrodes so that the first electrode becomes a negative electrode and the second electrode becomes a positive electrode, thereby desorbing the dissolved solids adsorbed to the porous electrode therefrom; and

flowing an acidic aqueous solution through the flow path of the flow-through capacitor while applying a second reverse electric potential difference across the first and second electrodes to remove deposits formed in the flow-through capacitor.

The flow path may include a spacer defining a fluid flow channel to permit the fluid to contact the first electrode and the second electrode.

The flow-through capacitor may further include a charge barrier against a cation between the first electrode and the spacer, a charge barrier against an anion between the second electrode and the spacer, or both of them.

The adsorbing the dissolved solids to the porous electrode and the desorbing the dissolved solids adsorbed to the porous electrode therefrom may be repeated a predetermined number of times.

The adsorbing the dissolved solids to the porous electrode and the desorbing the dissolved solids adsorbed to the porous electrode therefrom may be repeated until deionization efficiency of the flow-through capacitor becomes less than or equal to 70% of an initial deionization efficiency thereof.

The electric potential difference applied across the first and second electrodes may be greater than or equal to about 0.5 volts and less than or equal to about 3 volts.

The first reverse electric potential difference applied across the first and second electrodes may be from about −3 volts to 0 volts.

The acidic aqueous solution may include an organic acid, an inorganic acid, or a combination thereof.

The acidic aqueous solution may have pH of about 1 to about 3.

The second reverse electric potential difference applied across the first and second electrodes may be from about −3 volts to −1.2 volts.

The method may further include flowing water through the flow path of the flow-through capacitor to remove the acidic aqueous solution remaining therein after the removal of the deposits.

Another example embodiment of the present disclosure relates to a capacitive deionization apparatus including:

a housing having an inlet for introduction of a fluid to be treated or an acidic aqueous solution and an outlet for withdrawal of a treated fluid or the acidic aqueous solution;

a flow-through capacitor being disposed in the housing, the flow through capacitor including at least one pair of porous electrodes including a first electrode and a second electrode including an electrode material having a surface area for electrostatic adsorption of dissolved solids; and a flow path being present between the first electrode and the second electrode;

a supply unit for supplying the fluid to be treated to the inlet; and

a supply unit for supplying an acidic aqueous solution having pH of about 1 to about 3 to the inlet.

The flow path may include a spacer defining a fluid flow channel to permit the fluid to contact the first electrode and the second electrode.

The flow-through capacitor may further include a charge barrier against a cation between the first electrode and the spacer, a charge barrier against an anion between the second electrode and the spacer, or both of them.

The charge barrier against a cation may include an anion exchange membrane, and the charge barrier against an anion may include a cation exchange membrane.

The first electrode and the second electrode may further include a current collector disposed at an opposite side to the flow path.

The first electrode and the second electrode may include a polarity-variable electrode.

According to the method of the aforementioned embodiments, the capacitive deionization may be carried out for an extended period of time without showing a substantial decrease in ion adsorption efficiency, and thereby the capacitive deionization apparatus may exhibit higher efficiency of deionization and a longer lifespan.

### BRIEF DESCRIPTION OF DRAWINGS

These and/or other aspects will become apparent and more readily appreciated from the following description of the embodiments, taken in conjunction with the accompanying drawings, in which:

FIG. 1A, FIG. 1B, and FIG. 1C are schematic cross-sectional views of flow-through capacitors according to various embodiments.

FIG. 2 is a view schematically illustrating a process of forming deposits in the flow-through capacitor according to an embodiment.

FIG. 3 is a view schematically illustrating a process of removing deposits in the flow-through capacitor according to an embodiment.

FIG. 4 is a view illustrating the results of operating a capacitive deionization unit cell of the comparative example.

FIG. 5 is a view illustrating the results of operating a capacitive deionization unit cell of the example.

FIG. 6 is a schematic cross-sectional view of an embodiment of a capacitive deionization apparatus according to an embodiment.

### DETAILED DESCRIPTION

Advantages and characteristics of this disclosure, and a method for achieving the same, will become evident referring to the following example embodiments together with the drawings attached hereto. However, this disclosure may be embodied in many different forms and is not be construed as limited to the embodiments set forth herein; rather, these embodiments are provided so that this disclosure will satisfy applicable legal requirements. Therefore, in some embodiments, well-known process technologies are not explained in detail in order to avoid vague interpretation of the example embodiments. If not defined otherwise, all terms (including technical and scientific terms) in the specification may be defined as commonly understood by one skilled in the art. The terms defined in a generally-used dictionary may not be interpreted ideally or exaggeratedly unless clearly defined. In addition, unless explicitly described to the contrary, the word “comprise” and variations such as “comprises” or “comprising” will be understood to imply the inclusion of stated elements but not the exclusion of any other elements.

In addition, the singular includes the plural unless mentioned otherwise.

Example embodiments may be described referring to example schematic diagrams. Accordingly, the regions shown in the drawings are overviews and do not limit the scope of the example embodiments. The same reference numerals designate the same constituent elements throughout the specification.

As used herein, the term “capacitive deionization apparatus” refers to a device that may separate/concentrate ions by passing fluids including at least one ion component to be separated or to be concentrated through the flow path formed between at least one pair of porous electrodes and applying a voltage thereto so as to adsorb the ion components onto the surfaces of the pores in the electrodes. The capacitive deionization apparatus include at least one flow-through capacitor and may have any geometry.

As used herein, the term “porous electrode” refers to a conductive structure including an electrically-conductive material and having a relatively high specific surface area due to the presence of pores therein having a diameter of nanometers or larger, for example, about 0.5 nm to about 5 μm.

As used herein, the term “ion exchange polymer” refers to a polymer including an ion exchange group on a main chain or a side chain thereof.

In an embodiment, a method of treating (e.g., deionizing) a fluid containing dissolved solids (for example, dissolved ions) includes:

obtaining a flow-through capacitor including at least one pair of porous electrodes including a first electrode and a second electrode including an electrode material having a surface area for electrostatic adsorption of dissolved solids; and a flow path being present between the first electrode and the second electrode;

flowing a fluid containing dissolved solids through the flow path of the flow-through capacitor;

applying an electric potential difference across the first and the second electrodes so that the first electrode becomes a positive electrode and the second electrode becomes a negative electrode, thereby adsorbing the dissolved solids contained in the fluid in the flow path to the porous electrode;

either removing the electric potential difference applied across the first and the second electrodes or applying a first reverse electric potential difference across the first and the second electrodes so that the first electrode becomes a negative electrode and the second electrode becomes a positive electrode, thereby desorbing the dissolved solids adsorbed to the porous electrode therefrom; and

flowing an acidic aqueous solution through the flow path of the flow-through capacitor while applying a second reverse electric potential difference across the first and the second electrodes so that the first electrode becomes a negative electrode and the second electrode becomes a positive electrode, thereby removing deposits formed in the flow through capacitor.

As mentioned above, the flow-through capacitor includes at least one pair of porous electrodes including a first electrode and a second electrode including an electrode material having a surface area for electrostatic adsorption of dissolved solids; and a flow path being present between the first electrode and the second electrode.

The electrode material having a surface area for electrostatic adsorption of dissolved solids may be any porous material that is known to be available for a capacitive deionization electrode. In non-limiting examples, the electrode material may be selected from the group consisting of carbon materials (e.g., activated carbon, carbon nanotubes (CNT), activated carbon fiber, carbon nanofibers, carbon aerogel, mesoporous carbon such as ordered mesoporous carbon, and graphite oxide), a metal oxide, and a combination thereof.

In addition to the electrode material, the electrode may further include any additives that are known to be added to the capacitive deionization electrode such as a binder, a crosslinker, an electrically conductive agent, or a combination thereof.

As the flow-through capacitor is subjected to a repeated charging/discharging process, its mechanical strength may easily deteriorate and the loss of the electrode material caused thereby may in turn result in a shortened life-span of the electrode. In order to prevent such problems, the binder may play a role of binding electrode materials with each other to form a continuous structure and to help the electrode being well-attached to a current collector, thereby enhancing mechanical properties of the electrode.

The amount of the binder is not particularly limited, and may be selected appropriately so long as it does not have an adverse effect on the electrical properties of the electrode. Types of the binder are not particularly limited, and may be selected from any known compounds. For example, the binder may include at least one hydrophilic polymer selected from a polyacrylic acid, a poly(acrylic acid-maleic acid) copolymer, polyvinyl alcohol, cellulose, polyvinylamine, chitosan, polyacrylamide, a poly(acrylamide-acrylic acid) copolymer, a poly(styrene-acrylic acid) copolymer, and a combination thereof. In other embodiments, the binder may include at least one polymer selected from polystyrene, polyvinylchloride, carboxylated polyvinylchloride, polyvinylfluoride, polyamide, polyvinylpyrrolidone, polyurethane, polytetrafluoroethylene, polyvinylidene fluoride, polyethylene, polypropylene, a styrene-butadiene rubber, an acrylated styrene-butadiene rubber, epoxy resin, and a combination thereof.

The binder may be an ion exchange binder including a cation exchange group or an anion exchange group. The ion exchange binder may be an ion exchange polymer. The electrode including the ion exchange binder may be an electrode having an ion exchange group. For example, in the capacitor, the first electrode (that becomes a positive electrode when a charging voltage is applied) may include an anion exchange polymer having an anion exchange group, while the second electrode (that becomes a negative electrode when a charging voltage is applied) may include a cation exchange polymer having a cation exchange group. The cation exchange group may be selected from a sulfonic acid group (—SO₃H), a carboxyl group (—COOH), a phosphonic acid group (—PO₃H₂), a phosphinic acid group (—HPO₃H), an arsenic acid group (—AsO₃H₂), and a selenonic acid group (—SeO₃H), and the anion exchange group may be selected from a quaternary ammonium salt (—NH₃⁺), a primary, secondary, or tertiary amine group (—NH₂, —NHR, —NR₂), a quaternary phosphonium group (—PR₄⁺), and a tertiary sulfonium group (—SR₃⁺).

The electrode may further include at least one of an electrically conductive agent and/or a crosslinking agent. The electrically conductive agent may enhance the conductivity of the electrode. Types of the conductive agent are not particularly limited, and it is possible to use any materials that are used for fabricating electrodes. By way of non-limiting examples, the electrically conductive agent may be selected from carbon materials such as carbon black, vapor growth carbon fiber (VGCF), natural graphite, artificial graphite, acetylene black, ketjen black, and a carbon fiber; metallic materials such as a metal powder or a metal fiber of copper, nickel, aluminum, or silver; conductive polymers such as a polyphenylene derivative; and a mixture thereof. The crosslinking agent may play a role of forming a crosslinking bond between the polymer chains of the binder. The crosslinking agent may include a compound having at least two carboxyl groups, a compound having at least two hydroxyl groups, a compound having at least two amine groups, a compound having at least two epoxy groups, or a combination thereof. The amounts of the electrically conductive agent and/or the crosslinking agent are not particularly limited, and may be appropriately selected without having an adverse effect on the electrical conductivity of the electrode.

The thickness of the electrode is not particularly limited, and may be appropriately selected. For example, the thickness of the electrode may range from about 50 μm to about 500 μm, for example about 100 μm to about 300 μm. When multiple pairs of electrodes are included in a capacitive deionization apparatus as described below, both sides of the current collector may be combined with the electrodes. The current collector is electrically connected to a power source, thereby applying a voltage to the electrode. The current collector may include a graphite plate or a graphite foil. In other embodiments, the current collector may include at least one metal selected from the group consisting of Cu, Al, Ni, Fe, Co, and Ti, or a metal mixture or alloy thereof. The current collector may be in the form of a sheet, a foam, or a mesh, but it is not limited thereto.

The flow-through capacitor may include a flow path that may be defined by a pair of electrodes (e.g., the first electrode and the second electrode). The flow path may include a spacer forming a fluid flow channel to permit the fluid to contact the first electrode and the second electrode. The spacer may be made of any electrically insulating material that is capable of providing a flow channel for a fluid and preventing the electrodes from being short-circuited, and may have any of a variety of shapes. As non-limiting examples, the spacer structure may be an open mesh, a non-woven fabric, a woven fabric, or a foam. By way of non-limiting examples, the spacer may include polyesters such as polyethylene terephthalate, polyolefins such as polypropylene and polyethylene, polyamides such as nylon, an aromatic vinyl-based polymer such as polystyrene, cellulose derivatives such as cellulose, methyl cellulose, and acetylmethyl cellulose, a polyetherether ketone, polyimides, polyvinylchlorides, or a combination thereof. The width of the flow path (e.g., the thickness of the spacer) is not particularly limited, but it may range from about 50 μm to about 500 μm, and specifically, from about 100 μm to about 300 μm, depending on the flow rate and the solution resistance.

The flow-through capacitor may further include a charge barrier against a cation (also referred to herein as a “charge barrier against cations”) between the first electrode (the positive electrode) and the spacer, a charge barrier against an anion (also referred to herein as a “charge barrier against anions”) between the second electrode (the negative electrode) and the spacer, or both. The charge barrier against the cation may be an anion exchange membrane (an anion permselective membrane), and the charge barrier against the anion may be a cation exchange membrane (a cation permselective membrane). The cation or anion permselective membrane may be prepared by an appropriate method, or is commercially available (e.g., Neosepta CMX, Neosepta AMX, or the like manufactured by Tokuyama).

The flow-through capacitor may have any geometric structure, and its structure is not particularly limited. The flow-through capacitor may be produced by any known method and is commercially available. In non-limiting examples, the flow-through capacitor will be explained with reference to the drawings.

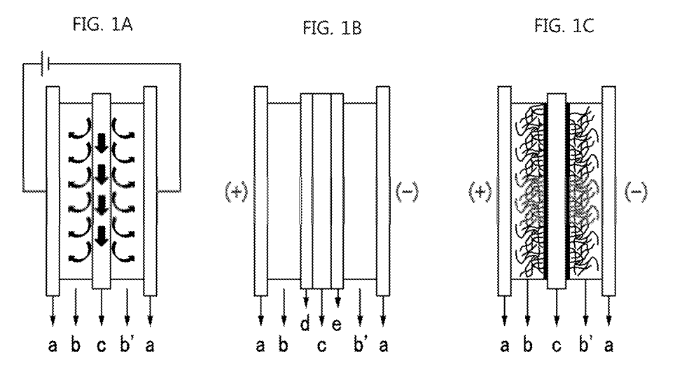

FIG. 1A, FIG. 1B, and FIG. 1C are schematic cross-sectional views of flow-through capacitors according to various embodiments. Referring to FIG. 1A, porous electrodes b and b′ are coated on a current collector a, and a flow path c is provided between the porous electrodes b and b′ (for example, by a spacer).

In the flow-through capacitor shown in FIG. 1B, porous electrodes b and b′ are coated on a current collector a, a flow path c is provided between the porous electrodes b and b′ (for example by a spacer), and an anion exchange membrane d and a cation exchange membrane e are inserted between the porous electrodes b and b′ and the flow path c. In the flow-through capacitor shown in FIG. 1C, the porous electrodes b and b′ are coated on a current collector a, and a spacer c is inserted between the porous electrodes b and b′ to define a flow path, wherein the porous electrode b is a positive electrode including an anion exchange binder, and the electrode b′ is a negative electrode using a cation exchange binder.

When a charging/discharging voltage is applied to the capacitor, a reaction may occur and thereby ions to be removed may be adsorbed to the electrode. At the same time, however, a side reaction may also occur at the same electrode, and thereby a counter ion may be desorbed therefrom. This phenomenon may reduce the deionization efficiency per amount of the electrical current being applied. In order to address such problems, as in the membrane capacitive deionization apparatus, the capacitor may include an ion exchange membrane between the electrode and the flow path. In addition, by using an electrode including an ion exchange binder as a charge barrier (i.e., using an electrode having an ion exchange group), it becomes possible to suppress the reaction triggering the desorption of the counter ions.

The method includes flowing a fluid containing dissolved solids through the flow path of the flow-through capacitor as explained above; applying an electric potential difference across the first and second electrodes so that the first electrode becomes a positive electrode and the second electrode becomes a negative electrode, thereby adsorbing the dissolved solids contained in the fluid in the flow path to the porous electrode; and either removing the electric potential difference or applying a first reverse electric potential difference across the first and second electrodes so that the first electrode becomes a negative electrode and the second electrode becomes a positive electrode, thereby desorbing the dissolved solids adsorbed to the porous electrode therefrom.

The dissolved solid may be an ion (a cation or an anion). The fluid may include water. The fluid is supplied to the capacitor in such a manner that the fluid is allowed to flow through the flow path. The manner of supplying the fluid is not particularly limited, and may be selected appropriately depending on the structure of the capacitor.

While the fluid including the dissolved solid is flowing through the flow path formed between the electrodes, an electric potential difference is applied across the first electrode and the second electrode such that the first electrode and the second electrode become the positive electrode and the negative electrode, respectively. Hereinafter, such an electric potential difference may also be referred to as a charging voltage. As a result of this, the dissolved solid is separated from the fluid flowing through the flow path and adsorbed to the porous electrodes. For example, the dissolved solid may be an anion (such as Cl⁻, SO₄²⁻, or CO₃⁻) which may be adsorbed to the first electrode (i.e., the positive electrode). In addition, the dissolved solid may be a cation (such as Ca²⁺, Mg²⁺, or Na⁺) which may be adsorbed to the second electrode (i.e., the negative electrode). When the charging voltage is applied, the electric potential difference is not particularly limited, and may be controlled appropriately. For example, the electric potential difference may be lower than one that triggers electrolysis of water. In an embodiment, the electric potential difference may range from about 0.5 volts to about 3.0 volts, for example, from about 1.2 volts to about 2.0 volts, but it is not limited thereto.

The dissolved solids (e.g., the ions) being adsorbed to the first and second electrodes may be desorbed therefrom either by removing the electric potential difference applied between the first and second electrodes or by forming a first reverse electric potential difference across the first and second electrodes such that the first electrode becomes a negative electrode and the second electrode becomes a positive electrode. The first reverse potential difference is not particularly limited, but it may be controlled appropriately. In an embodiment, the first reverse potential difference may range from about −3.0 volts to about 0 volts, for example, from about −2.5 volts to about −1.5 volts, but it is not limited thereto.

The adsorption and the desorption of the dissolved solids may be repeated a predetermined number of times, for example, at least five times, at least 10 times, or at least 20 times, but it is not limited thereto.

Then, the treating method includes flowing an acidic aqueous solution through the flow path of the flow-through capacitor while applying a second reverse electric potential difference across the first and second electrodes to remove deposits formed in the flow-through capacitor. As stated above, as the adsorption and desorption of the dissolved solids are repeated, the deionization efficiency of the capacitor may gradually decrease to less than or equal to about 90%, for example, less than or equal to about 80%, less than or equal to about 70%, less than or equal to about 60%, or less than or equal to about 50% of the initial deionization efficiency. The flowing an acidic aqueous solution through the flow path while applying a second reverse electric potential difference across the first and second electrodes (hereinafter, also referred to as the regeneration step of the capacitor) may effectively suppress such a decrease in deionization efficiency. As used therein, the initial deionization efficiency is based on the minimum conductivity of the treated water attainable in the first adsorption cycle.

Without wishing to be bound by any theory, this may result from the following. A capacitive deionization (CDI) apparatus including a flow-through capacitor (hereinafter, also referred to as a cell) may be required to operate at a high cell voltage (for example, at a voltage of about 1.5 volts or higher) if a fluid including a large amount of ions is to be treated within a relatively short time. However, when the apparatus is subjected to a charging/discharging cycle under such a high voltage, electrolysis of water may also occur in addition to the adsorption of ions as shown in reactions (1) and (2), and this may cause the formation of deposits (e.g., limescale) that may occur in accordance with reactions (3) and (4) and such deposits may greatly reduce the deionization efficiency of the CDI apparatus.

2H₂O+2e⁻→H2(g)+2OH⁻ (1)

O₂+2H₂O+4e⁻→4OH⁻ (2)

Ca²⁺+2OH⁻→Ca(OH)₂(s) (3)

Mg²⁺+2OH⁻→Mg(OH)2(s) (4)

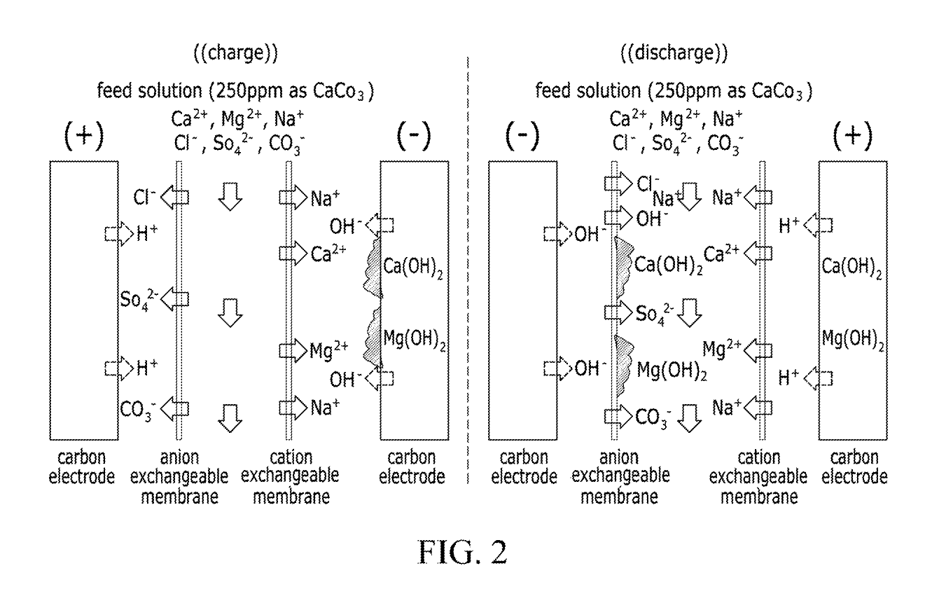

In non-limiting examples, FIG. 2 schematically illustrates the scale formation that may occur in an MCDI apparatus including a charge barrier during the ion adsorption by the applied charging voltage and the ion desorption. With reference to FIG. 2, in the ion adsorption stage, the cations included in the feed solution pass through the cation exchange membrane and move toward the negative electrode, while the anions included in the feed solution pass through the anion exchange membrane and move toward the positive electrode. However, when a high voltage (for example, of greater than or equal to about a voltage that triggers water electrolysis) is applied for rapid removal of the ions, hydrogen ions and hydroxide ions may be generated at the positive electrode and negative electrode, respectively.

The hydroxide ions may combine with hard cations (e.g., Ca²⁺, Mg²⁺) to form limescale at the surface of the negative electrode. Meanwhile, when the reverse potential difference is applied during the ion desorption stage, the hydroxide ions may pass through the anion exchange membrane and move into the flow path, and thereby they may combine with the hard cations being present in the flow path to form limescale. The scale thus formed may greatly reduce the ion adsorption capacity of the electrode and the ion adsorption efficiency of the CDI apparatus.

In order to remove the scale, an acidic aqueous solution having a high concentration of hydrogen ions is supplied to the flow path. However, in such case, the electrode and the ion exchange membrane are inevitably damaged by the highly acidic aqueous solution, and the scale formed on the surface of the carbon electrode (i.e., the second (negative) electrode in charging cycle) may hardly be removed by the aforementioned measure.

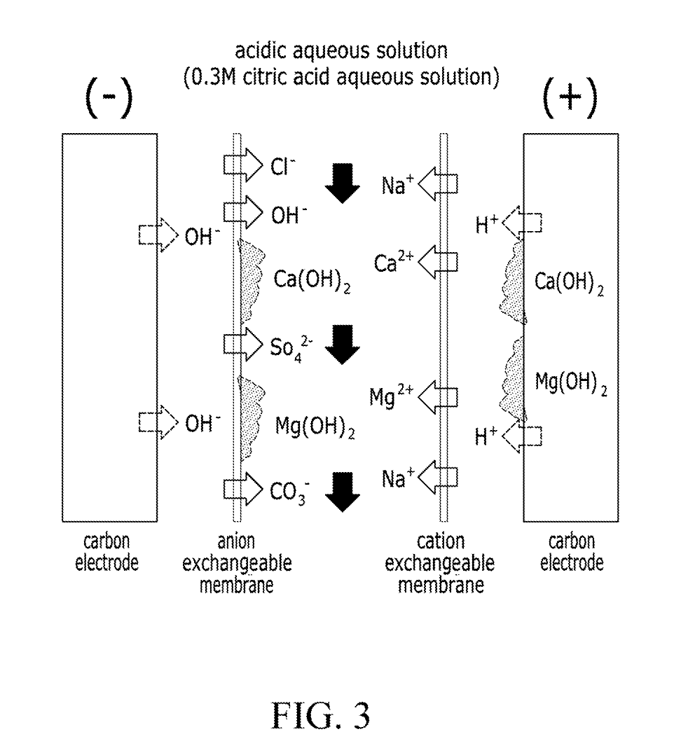

In contrast, in the treating method of the embodiment, an acidic aqueous solution flows through the flow path while a reverse electric potential difference is applied across the first electrode and the second electrode (in an opposite direction to that of the charging voltage). FIG. 3 schematically illustrates a mechanism wherein scale is removed by acidic washing under the application of the voltage in a CDI apparatus including a charge barrier (e.g., an ion exchange membrane). As shown in FIG. 3, in the treating method of the embodiments, the acidic aqueous solution is allowed to flow through the flow path, and at the same time, a reverse electric potential is applied to the electrodes, triggering the electrolysis of water. In addition, the reverse electric potential is applied under the acidic condition and thus the electrolysis of water may occur at a relatively low voltage. Surprisingly, if the acidic aqueous solution is allowed to flow through the flow path while the reverse voltage is applied across the flow path, the scale may be easily removed even when the acidic aqueous solution has a much lower concentration of hydrogen ions. In addition, as hydrogen ions may be generated between the cation exchange membrane and the second electrode by the electrolysis of water, the scale deposited on the second electrode may be efficiently removed.

The acidic aqueous solution being supplied to the flow path may include an organic acid, an inorganic acid, or a combination thereof. As long as the acid may provide a desired pH (i.e., a desired hydrogen ion concentration), the types thereof are not particularly limited. In an embodiment, the organic acid may include citric acid, acetic acid, formic acid, or a combination thereof, and the inorganic acid may include sulfuric acid, hydrochloric acid, nitric acid, phosphoric acid, or a combination thereof.

The acidic aqueous solution may have pH of less than or equal to about 3, for example, less than or equal to about 2. The acidic aqueous solution may have pH of greater than or equal to about 1, for example greater than or equal to about 1.5. By using the acidic aqueous solution having pH within the aforementioned range, it is possible to efficiently remove the deposits formed in the capacitor (including the scale deposited inside the ion exchange membrane that is on the surface of the negative electrode). The second reverse electric potential difference may range from about −3 volts to about −1.2 volts, for example, from about −2 volts to about −1.5 volts. The absolute value of the second reverse electric potential difference may be larger than that of charging/discharging voltage. When the second reverse electric potential difference is within the aforementioned range, it becomes possible to remove the scale effectively using the acidic aqueous solution having a relatively low value of hydrogen ion concentration.

The method may further include supplying water to the flow-through capacitor, and allowing the water to flow through the flow path of the flow-through capacitor to remove the acidic aqueous solution remaining therein after the deposits are removed. Types of the water are not particularly limited, and may be selected appropriately. In an embodiment, the water may be deionized water, tap water, or a combination thereof.

The treating method of the foregoing embodiments makes it possible to effectively remove scale generated during a large number of the adsorption/desorption cycles of the dissolved solids (i.e., the dissolved ions), thereby significantly extending the lifespan of the CDI apparatus.

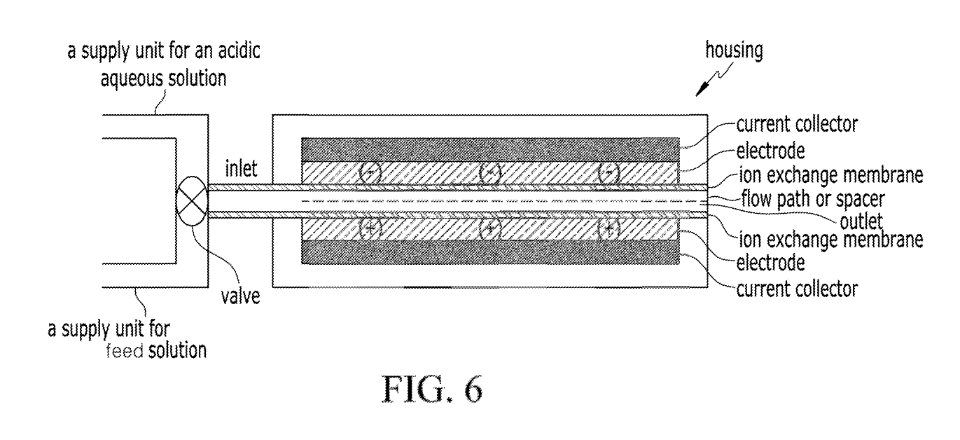

FIG. 6 is a schematic cross-sectional view of an embodiment of a capacitive deionization apparatus according to an embodiment.

Referring to FIG. 6, in an example embodiment of the present disclosure, a capacitive deionization apparatus includes:

a housing having an inlet for the introduction of a fluid to be treated or an acidic aqueous solution and an outlet for the withdrawal of a treated fluid or the acidic aqueous solution;

a flow-through capacitor disposed in the housing, the flow-through capacitor including at least one pair of porous electrodes including a first electrode and a second electrode including an electrode material having a surface area for electrostatic adsorption of dissolved solids; and a flow path being present between the first electrode and the second electrode;

a supply unit for supplying the fluid to be treated to the inlet; and

a supply unit for supplying an acidic aqueous solution having pH of about 1 to about 3 to the inlet.

The housing may have any shape depending on the shape and the type of the flow-through capacitor, and is not particularly limited. The housing has an inlet for the introduction of a fluid to be treated or an acidic aqueous solution, and an outlet for the withdrawal of a treated fluid or the acidic aqueous solution. Materials for the housing are known in the art and are not particularly limited.

The flow path may include a spacer defining a fluid flow channel to permit the fluid to contact the first electrode and the second electrode. The flow-through capacitor may further include a charge barrier against a cation between the first electrode and the spacer, a charge barrier against an anion between the second electrode and the spacer, or both of them. The charge barrier against a cation may include an anion exchange membrane, and the charge barrier against an anion may include a cation exchange membrane. The first electrode and the second electrode may further include a current collector disposed at an opposite side to the flow path. The first electrode and the second electrode may include a polarity-variable electrode.

Besides the foregoing, details for the flow-through capacitor are the same as set forth above.

The supply unit for the fluid to be treated and the supply unit for the acidic aqueous solution may be selectively communicated with the inlet by using a valve. The supply unit for the fluid to be treated and the supply unit for the acidic aqueous solution may have any shape, and may be made of any materials that are not affected by the fluid to be treated and the acidic aqueous solution.

The capacitive deionization apparatus may be applied in a range of applications such as production of ultra-pure water, a water purification process removing a salt (such as desalination of sea water), a deionization process removing a calcium salt (changing hard water into soft water), and production of drinking water, as well as for home appliances such as washing machines, dishwashers, steam cleaners, refrigerators, water purifiers, and coffee machines, boilers with a function of removing ions from distilled water, and production processes of industrial water.

The following examples illustrate one or more example embodiments in more detail. However, it is understood that the scope of the example embodiments is not limited to these examples.

### MODE FOR INVENTION

### EXAMPLES

### Preparation Example

### [1] Preparation of a Negative Electrode Having a Cation Exchange Group

12.6 grams of an aqueous solution of polyvinyl alcohol (PVA) (purchased from Aldrich Co. Ltd., molecular weight of 89,000 to 98,000), 0.774 grams of sulfosuccinic acid (purchased from Aldrich Co. Ltd., a 70% aqueous solution), and 2.898 grams of sulfosalicylic acid (purchased from Aldrich Co. Ltd.) are mixed to prepare a binder solution. 3 grams of activated carbon (PGW, manufactured by Kuraray Co. Ltd., specific surface area: 1200 m²/g) and 0.45 grams of Super P (manufactured by Timcal Graphite & Carbon, carbon black, average particle size: 40 nm) are added to the binder solution to obtain a slurry for an electrode. The slurry thus obtained is applied to a graphite sheet (manufactured by Dongbang Carbon Co. Ltd., thickness: 250 μm) using a doctor blade at a thickness of 200 μm, dried, and then heated at a temperature of 130° C. for two hours to prepare an electrode.

### [2] Preparation of a Positive Electrode Having an Anion Exchange Group

12.6 grams of an aqueous solution of polyvinyl alcohol (PVA) (purchased from Aldrich Co. Ltd., molecular weight of 89,000 to 98,000), 0.36 grams of glutaric acid, and 3.15 grams of glycidyl trimethyl ammonium chloride are mixed to prepare a binder solution. 3 grams of activated carbon (PGW, manufactured by Kuraray Co. Ltd., specific surface area: 1200 m²/g) and 0.45 grams of Super P (manufactured by Timcal Graphite & Carbon, carbon black, average particle size: 40 nm) are added to the binder solution to obtain a slurry for an electrode. The slurry thus obtained is applied to a graphite sheet (manufactured by Dongbang Carbon Co. Ltd., thickness: 250 μm) using a doctor blade at a thickness of 200 μm, dried, and then heated at a temperature of 130° C. for two hours to prepare an electrode.

### [3] Assembling of the Flow-Through Capacitor (Hereinafter Referred to as Capacitive Deionization Unit Cell)

A polyamide mesh (manufactured by Sefar Co. Ltd., thickness: 100 μm) is used as a spacer. A capacitive deionization unit cell (graphite sheet/positive electrode/spacer/negative electrode/graphite sheet) is made by assembling the positive electrode obtained above, the negative electrode obtained above, and the spacer, as shown in FIG. 1 (C).

### Comparative Example

[1] Hard water having a CaCO₃ concentration of 250 ppm (conductivity: about 800 μS/cm) is fed into the CDI unit cell being manufactured from the above preparation example at room temperature at a rate of 27 mL/min. The current collector of the cell is connected to a power supply and a voltage of 2.0 volts is applied to the cell for one minute to conduct ion adsorption. Then, a voltage of −1.5 volts is applied to the cell for five minutes to conduct ion desorption. A cycle consisting of one minute of adsorption and five minutes of desorption is repeated 50 times. The conductivity of the deionized water passing the apparatus is measured with a flow-type conductivity meter in real time.

[2] After the 50^{th} cycle, an aqueous solution of citric acid (0.3 mol/L, pH: 2) is allowed to flow through the unit cell at a rate of 50 ml/min for one hour. Then, deionized water is allowed to flow through the unit cell at a rate of 50 ml/min for one hour. Subsequently, a cycle consisting of one minute of adsorption and five minutes of desorption is repeated 50 times under the same conditions as set forth in item [1]. The conductivity of the deionized water passing the apparatus is measured with a flow-type conductivity meter in real time.

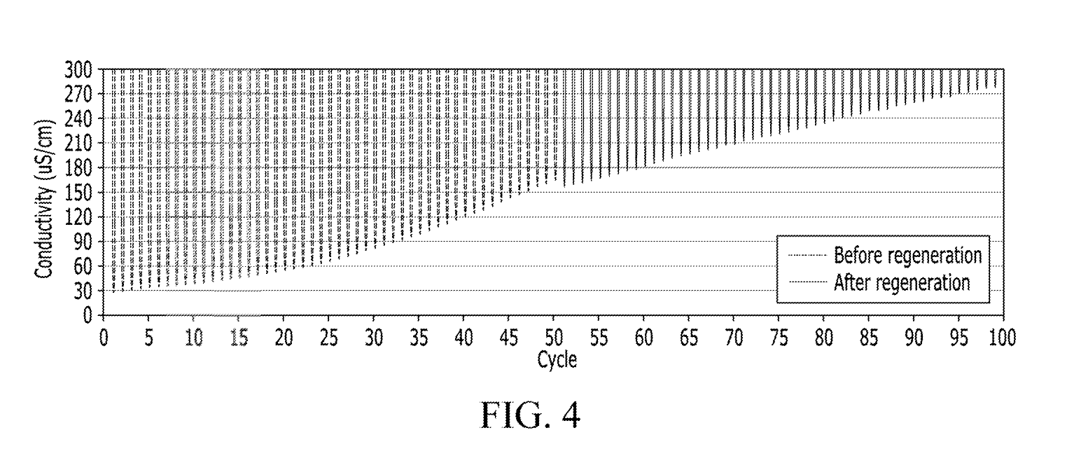

FIG. 4 shows a graph plotting the conductivity versus the number of cycles as measured from the foregoing comparative example. The results of FIG. 4 confirm that using a 0.3 M citric acid solution does not bring forth any substantial improvement in the deionization efficiency.

### Example

An ion adsorption/desorption experiment is carried out in the same manner as set forth in the comparative example except that after the 50^{th} cycle, a voltage of −2.0 volts is applied to the CDL unit cell while an aqueous solution of citric acid (0.3 mol/L, pH: 2) is allowed to flow through the unit cell at a rate of 50 ml/min for one hour.

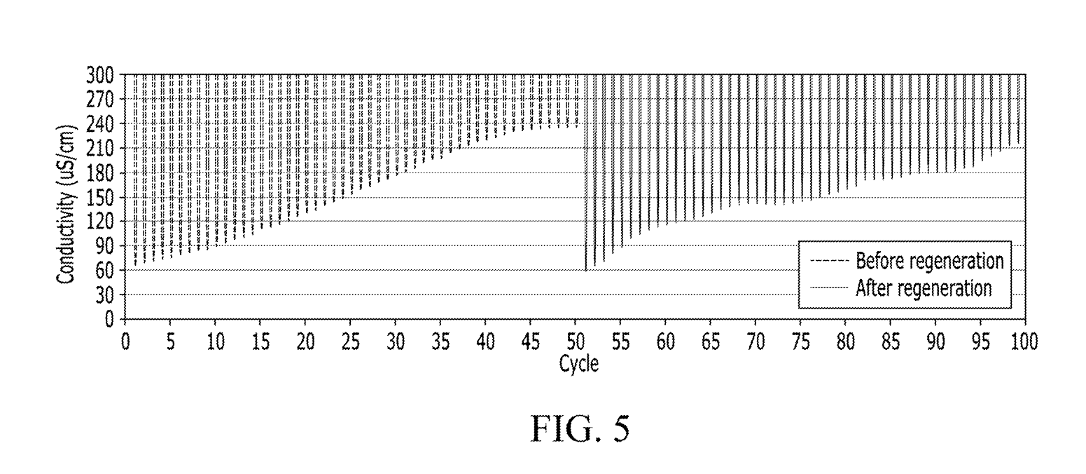

FIG. 5 shows a graph plotting the conductivity versus the number of cycles as measured from the foregoing example. The results of FIG. 5 confirm that, according to the method of the example, the deionization efficiency is greatly increased and thereby the unit cell may exhibit the initial deionization efficiency even after the 50^{th} cycle.

While this disclosure has been described in connection with what is presently considered to be practical example embodiments, it is to be understood that the example embodiments are not limited to the disclosed embodiments, but, on the contrary, is intended to cover various modifications and equivalent arrangements included within the spirit and scope of the appended claims.

### DESCRIPTION OF SYMBOLS

a: current collector
b, b′: electrode
c: spacer (or flow path)
d, d′: ion exchange membrane

1. A method of treating a fluid containing dissolved solids, comprising:
obtaining a flow-through capacitor, the flow-through capacitor including,
at least one pair of porous electrodes, the at least one pair of porous electrodes including a first electrode and a second electrode, each electrode of the first and second electrodes including an electrode material, the electrode material having a surface area, each electrode being configured to electrostatically adsorb dissolved solids; and
a flow path between the first electrode and the second electrode;
flowing a fluid through the flow path of the flow-through capacitor, the fluid including dissolved solids;
applying an electric potential difference across the first and second electrodes such that
the first electrode becomes a positive electrode and the second electrode becomes a negative electrode, and
the dissolved solids included in the fluid in the flow path are adsorbed to at least one porous electrode of the porous electrodes;
causing the first electrode to become a negative electrode and the second electrode to become a positive electrode, such that the dissolved solids adsorbed to the at least one porous electrode are desorbed therefrom, based on performing one of removing the electric potential difference or applying a first reverse electric potential difference across the first and second electrodes and
flowing an acidic aqueous solution through the flow path of the flow-through capacitor, concurrently with applying a second reverse electric potential difference across the first and second electrodes to remove deposits formed in the flow through capacitor.

2. The method of claim 1, wherein the flow path includes a spacer, the spacer defining a fluid flow channel, the spacer configured to permit the fluid to contact the first electrode and the second electrode.

3. The method of claim 1, wherein the flow-through capacitor further includes
a charge barrier against cations, the charge barrier against cations being between the first electrode and a spacer, and
a charge barrier against anions, the charge barrier against anions being between the second electrode and the spacer.

4. The method of claim 1, further comprising:
iteratively performing, for a particular quantity of iterations,
the applying the electric potential difference across the first and second electrodes, and
the causing the first electrode to become a negative electrode and the second electrode to become a positive electrode.

5. The method of claim 4, further comprising:
iteratively performing, until the flow-through capacitor has a deionization efficiency that is less than or equal to 70% of an initial deionization efficiency of the flow-through capacitor,
the applying the electric potential difference across the first and second electrodes, and
the causing the first electrode to become a negative electrode and the second electrode to become a positive electrode.

6. The method of claim 1, wherein,
the electric potential difference applied across the first and second electrodes is greater than or equal to about 0.5 volts and less than or equal to about 3 volts, and
the first reverse electric potential difference applied across the first and second electrodes is from about −3 volts to about 0 volts.

7. The method of claim 1, wherein the acidic aqueous solution includes at least one of an organic acid and an inorganic acid.

8. The method of claim 1, wherein the acidic aqueous solution has a pH of less than or equal to about 3.

9. The method of claim 1, wherein the acidic aqueous solution has apH of greater than or equal to about 1.

10. The method of claim 1, where the second reverse electric potential difference applied across the first and second electrodes is from about −3 volts to about −1.2 volts.

11. The method of claim 1, where an absolute value of the second reverse electric potential difference is less than or equal to an absolute value of the electric potential difference.

12. The method of claim 1, further comprising:
flowing water through the flow path of the flow-through capacitor to remove the acidic aqueous solution remaining therein after the removal of the deposits.

13. A capacitive deionization apparatus, comprising:
a housing including an inlet and an outlet, the inlet configured to introduce at least one of a fluid to be treated or an acidic aqueous solution into the housing, the outlet configured to withdraw the at least one of the treated fluid or the acidic aqueous solution from the housing;
a flow-through capacitor in the housing, the flow-through capacitor including
at least one pair of porous electrodes, the at least one pair of porous electrodes including a first electrode and a second electrode, each electrode of the at least one pair of porous electrodes including an electrode material, the electrode material having a surface area, each electrode being configured to electrostatically adsorb dissolved solids; and
a flow path between the first electrode and the second electrode;
a supply unit configured to supply the fluid to be treated to the inlet; and
a supply unit configured to supply an acidic aqueous solution to the inlet, the acidic aqueous solution having pH of about 1 to about 3.

14. The capacitive deionization apparatus of claim 13, wherein the flow path includes a spacer, the spacer defining a fluid flow channel, the spacer configured to permit the fluid to contact the first electrode and the second electrode.

15. The capacitive deionization apparatus of claim 13, wherein the flow-through capacitor further includes at least one of,
a charge barrier against cations, the charge barrier against cations being between the first electrode and the spacer, and
a charge barrier against anions, the charge barrier against anions being between the second electrode and the spacer.

16. The capacitive deionization apparatus of claim 13, wherein,
the charge barrier against cations includes an anion exchange membrane, and
the charge barrier against anions includes a cation exchange membrane.

17. The capacitive deionization apparatus of claim 13, wherein each electrode of the first electrode and the second electrode further includes a current collector at an opposite side of the electrode, relative to a side exposed to the flow path.

18. The capacitive deionization apparatus of claim 13, wherein each electrode of the first electrode and the second electrode includes a polarity-variable electrode.
